(19) United States
(12) Patent Application Publication
(10) Pub. No.: US 2012/0013112 A1
(43) Pub. Date: Jan. 19, 2012

(54) Traction Device To Walk On Ice While Wearing Ice Skate Scabbard

(76) Inventor: Douglas Kapp, Rowayton, CT (US)

(21) Appl. No.: 13/182,081

(22) Filed: Jul. 13, 2011

Related U.S. Application Data
(60) Provisional application No. 61/363,853, filed on Jul. 13, 2010.

(51) Int. Cl. A63C 3/12; B23P 11/00; B32B 3/06

(52) U.S. Cl. 280/825; 428/99; 29/428

(57) ABSTRACT

An ice skate scabbard assembly or kit including a traction device attached to the bottom of an ice skate scabbard allowing for a wearer to walk onto ice while wearing the scabbard and to provide increased traction/friction, such that the wearer of the ice skate scabbard assembly will not fall while walking onto the ice. The assembly has at least one ice skate scabbard, at least one traction device and at least one attachment element for attaching the at least one ice skate scabbard to the at least one traction device.

### CROSS-REFERENCE TO RELATED APPLICATIONS

The present application claims the benefit under 35 U.S.C. §119(e) of the U.S. Provisional Patent Application Ser. No. 61/363,853, entitled “Traction Device To Walk On Ice While Wearing Ice Skate Scabbard” filed on Jul. 13, 2010, the content of which is incorporated herein by reference.

### FIELD OF THE INVENTION

An ice skate scabbard assembly or kit including a traction device attached to the bottom of an ice skate scabbard allowing for a wearer of ice skates to walk on ice while wearing the scabbard and providing increased traction/friction, such that the wearer of the ice skate scabbard assembly will not fall while walking on the ice and will have improved traction/friction on the bottom of the ice skate scabbards as the wearer is walking on the ice.

### BACKGROUND OF THE INVENTION

Ice skate scabbards protect ice skate blades from being damaged while being carried in a skate bag and also protect a user or wearer of ice skates from being inadvertently cut by the exposed blades. Ice skate scabbards are designed to protect ice skate blades from being damaged while a wearer walks on a non-skateable surface, such as concrete, dirt, asphalt, rubber, or any other such non-skateable surface. Scabbards are typically worn while walking to and from an ice surface, such as an ice rink or an ice pond, where the scabbards are removed from the ice skate blades prior to a wearer stepping on the ice.

Ice skate scabbards typically come in two separate designs. The first design involves a one-piece ice skate scabbard whereby a single ice skate scabbard is able to receive an entire ice skate blade. The second design involves a two-piece design, whereby two separate ice skate scabbards are used to hold and receive a single ice skate blade. In the second design, the first ice skate scabbard will receive approximately the front half of the ice skate blade, and the second ice skate scabbard will receive approximately the rear half of the ice skate blade. The second design allows for the two separate ice skate scabbards to be able to slide onto the front end and rear end of an ice skate blade, respectively. Furthermore, the two separate ice skate scabbards may be connected to one another via a spring or tensioning element, such that the scabbards are able to engage with the ice skate blade during walking, without coming off the blade.

Typically, scabbards do not have a gripping surface on the bottom surface of the scabbard that is suitable for providing a wearer with sufficient traction to be able to walk on ice while wearing the scabbard. If scabbards are not removed from the ice blades prior to stepping onto the ice, the lack of traction between the bottom of the scabbard and the ice will often cause the wearer to fall. Possible serious injury may result from the lack of traction between the scabbard and the ice, as the wearer may slip if using scabbards of prior art designs.

U.S. Pat. No. 6,666,479 (Maddaleni) teaches a friction enhancing material on the bottom of the scabbard which allows a skater to walk with the scabbard attached about the blade. However, the friction enhancing material 20 of Maddaleni does not allow a wearer to walk on the ice with the scabbard without risk of a fall, but rather, the friction enhancing material is only suitable for allowing a wearer to walk on a non-skateable surface without risking a possible serious injury. The friction enhancing material 20 of the pouch 12 is also made of rubber, preferably a soft rubber (Col. 4, lines 49-50 of Maddaleni), and thus, is not suitable for providing enough friction to allow a wearer to walk on ice with the scabbard without risk of a fall.

Furthermore, the purpose of Maddaleni is not to allow a user to walk on the ice and to prevent serious injury, but rather, Maddaleni provides an ice skate scabbard which protects the blade and the skater from cuts (Maddaleni, Col. 1, line 56-Col. 2, line 22). Maddaleni is not used to solve the problem of allowing a wearer to walk on ice while wearing the scabbards without risk of a fall.

U.S. Pat. No. 5,833,270 (Hubshman) teaches a cover and walking attachment for in-line skate wheels having a web with thread portion molded or sewn into the web. Hubshman also does not solve the problem of allowing a wearer to walk on ice with the scabbard without risk of a fall and is used for in-line skates rather than ice skates.

U.S. Pat. No. 5,303,955 (Zurnamer) teaches a roller skate guard having a rubbery or high-friction material so as to enable walking on pavement or other abrasive surfaces. However, Zurnamer does not solve the problem of allowing a wearer to walk on ice with the scabbard without risk of a fall and is used for in-line skates (roller skates) rather than ice skates.

U.S. Pat. No. 4,382,615 (Gronborg et al.) teaches an ice skate guard having anti-slipping means attached to the bottom surface of the guard, which increase the friction between the guard and the ground when the skater is walking on his/her skates with the guard on. However, Gronborg et al. do not solve the problem of allowing a wearer to walk on ice while wearing scabbards without risk of a fall.

U.S. Pat. No. 3,338,588 (Couture) teaches a scabbard with a lower wall having teeth or some other suitable engaging surface to maximize the gripping characteristics of the scabbard. The scabbard here appears to have the teeth or gripping surface built in. However, Couture also does not solve the problem of allowing a wearer to walk on ice with the scabbard without risk of a fall.

U.S. Pat. No. 1,992,291 (Cole) teaches an ice skate walker having a sole or tread portion having a slightly curved or arched contour having compressible anti-slipping means. This anti-slipping means can be made of rubber or recesses with a central pin. However, Cole, similar to other prior art references, does not solve the problem of allowing a wearer to walk on ice with the scabbard without risk of a fall. Furthermore, the anti-slipping means of Cole requires driving pins to hold it into place.

None of the prior art references teach a scabbard that has a traction device that allows a user to wear the scabbard onto the ice without a risk of a fall, as all of the prior art references do not provide sufficient friction/traction for the wearer while walking on the ice. This is a significant problem because serious injury may result from the lack of traction between the scabbard and the ice, as the wearer may slip if using scabbards of prior art designs.

Additionally, none of the prior art references teach an add-on device to existing scabbards to increase traction between the bottom of the scabbard and the surface of ice, when a wearer walks on ice.

### SUMMARY OF THE INVENTION

It is an object of the present invention and is a focus of the present application to provide an ice skate scabbard having a traction device that allows a wearer to wear the scabbard while walking on ice that decreases the chance of the wearer suffering a fall and provides increased traction while walking on ice.

The present invention provides for an abrasive material, such as sandpaper, metal oxide, or grit, to be added to a standard ice skate guard that does not provide sufficient traction on ice for a user. The present invention involves an ice skate scabbard assembly that includes this traction device on the bottom surface of the ice skate scabbard and is able to be worn onto ice without the wearer falling. The present invention prevents the wearer from falling when the wearer forgets to remove the ice skate scabbard before getting on the ice and allows the wearer to actually walk onto the ice and remove the scabbards anywhere on the ice that the wearer wishes. A wearer can also reverse this situation when choosing to exit the ice, by putting on the scabbards while standing on the ice and then walking off the ice.

The invention allows for the wearer to step out onto the ice and walk on the ice to wherever he or she pleases before removing his/her ice skate scabbards from the ice blades. With the invention, a wearer can walk to the ice in his/her ice skates with scabbards on, may choose to remove the scabbards or not, may step onto the ice, and may move away from the entrance and remove the scabbards. This prevents an unsafe condition at the entrance of an ice rink where multiple skaters are trying to enter the ice simultaneously after stopping to remove their scabbards. In this situation, there is an increased risk of injury.

Another object of the invention is to provide for an ice skate scabbard with traction device that encapsulates the toe and heel of the scabbard in such a way as to facilitate “natural” walking in ice skates while on the ice. Walking is done by having the heel landing first followed by a complete weight shift to the foot, followed by a push off by the toe before landing on the alternate foot, and allows for a user to wear the scabbards with traction device of the present invention, such that a user may walk naturally.

These and other objectives are achieved by providing an ice skate scabbard assembly for receiving a blade of an ice skate, the assembly comprising: an ice skate scabbard having a body for receiving the blade of the ice skate, the body having a front end, two side ends, a rear end, and a bottom, wherein an opening is formed between the two side ends, the front end and the rear end for receiving the ice skate blade; at least one traction device; and at least one attachment element, wherein the at least one traction device is attached to the bottom of the body of the scabbard via the at least one attachment element.

The scabbard may have the at least one traction device formed of sandpaper, metal oxide, or grit. The attachment element of the scabbard may be composed of glue or cement. The attachment element of the scabbard may also be composed of a double-sided sticky layer, which can attach to the at least one traction device and the body of the ice skate scabbard.

The at least one traction device may extend from the front end of the scabbard to the rear end of the scabbard along the bottom of the body of the scabbard. Spaces may be formed between the edges of the at least one traction device and the two side ends of the body of the scabbard, the spaces used for preventing the edges of the at least one traction device from fraying. The length of the at least one traction device may be at least 60% of the length of the ice skate scabbard. In certain embodiments, the at least one traction device makes the bottom of the ice skate scabbard less slippery. In certain embodiments, the length of the at least one traction device is less than the length of the ice skate scabbard. In certain embodiments, the width of the at least one traction device may be less than the width of the ice skate scabbard. In other embodiments, the width of the at least one traction device may be equal to the width of the ice skate scabbard.

Spaces may also be formed between the edges of the at least one traction device and the front and rear ends of the body of the scabbard, the spaces used for preventing the edges of the at least one traction device from fraying.

The metal oxide of the traction device may be specifically aluminum oxide. The front end of the body of the scabbard may sweep upwardly, as will be shown in FIG. 1.

The at least one traction device may also be composed of aluminum oxide imbedded by resin in a fabric. The fabric may be waterproof.

The ice skate scabbard assembly may be comprised of two or more traction devices. The two or more traction devices can fit on the single ice skate scabbard per ice skate blade design. Also, there can be three traction devices or more than three traction devices per ice skate scabbard.

In certain embodiments, the ice skate scabbard assembly may further comprise a second ice skate scabbard having a body for receiving a blade of a second ice skate, the body having a front end, two side ends, a rear end, and a bottom, wherein an opening is formed between the two side ends, the front end and the rear end for receiving the second ice skate blade; a second traction device; and a second attachment element; wherein the second traction device is attached to the bottom of the body of the ice skate scabbard via the second attachment element.

The assembly may be sold as two scabbards each scabbard having one or more traction devices, such that the one or more traction devices on each scabbards works for the first design described above.

The assembly may further comprise two traction devices for the first ice skate scabbard and two traction devices for the second ice skate scabbard. The assembly may also comprise three traction devices for the first ice skate scabbard and three traction devices for the second ice skate scabbard, or a contrary combination of traction devices per ice skate scabbard.

In certain embodiments, the at least one traction device and the at least one attachment element may be fused together or manufactured as a single piece. In certain embodiments, the at least one attachment element may be made of glue or an adhesive.

In certain embodiments the at least one attachment element may be made of a Velcro-like material. In certain embodiments the at least one attachment element may undergo a chemical reaction once it is attached to the ice skate scabbard and/or the at least one traction element, so that the at least one attachment element attaches the at least one traction element to the ice skate scabbard.

Other objects of the invention are achieved by providing a traction device for an ice skate scabbard comprising: a strip of material made from either sandpaper or metal oxide, wherein the material is attached to the bottom of an ice skate scabbard via an attachment element.

This traction device may be applied to any semi-hard or hard scabbard material. The semi-hard scabbard material may be plastic, nylon, rubber, wood, or leather. The at least one traction device may also be formed of sandpaper, metal oxide, or grit. The metal oxide may preferably be aluminum oxide. Additionally, the attachment element may be composed of glue, cement or any other such attachment means.

Further, the attachment element of the scabbard may also be composed of a double-sided sticky layer, which can attach to the at least one traction device and the body of the ice skate scabbard.

Other objects of the invention may be achieved by providing a scabbard for receiving a blade of an ice skate, the scabbard comprising: an ice skate scabbard having a body for receiving the blade of the ice skate, the body having a front end, two side ends, a rear end, and a bottom, wherein an opening is formed between the two side ends, the front end and the rear end for receiving the ice skate blade; at least one traction device; and at least one attachment element, wherein the at least one traction device is attached to the bottom of the body of the scabbard via the at least one attachment element, and wherein the at least one traction device is made from aluminum oxide imbedded by resin in a fabric.

Other objects of the invention may be achieved by providing an ice skate scabbard assembly for receiving a blade of an ice skate, the assembly comprising: a first ice skate scabbard having a body for receiving the blade of the ice skate, the body having a front end, two side ends, and a bottom, wherein an opening is formed between the two side ends and the front end for receiving the ice skate blade; a second ice skate scabbard having a body for receiving the blade of the ice skate, the body having a front end, two side ends, and a bottom, wherein an opening is formed between the two side ends and the front end for receiving the ice skate blade; at least two traction devices; and at least two attachment elements, wherein at least one traction device is attached to the bottom of the body of the first ice skate scabbard via the at least one attachment element, and wherein at least one traction device is attached to the bottom of the body of the second ice skate scabbard via the at least one attachment element, wherein the first ice skate scabbard and the second ice skate scabbard are used in combination to receive the blade of the ice skate. This is an example of the second design for ice skate scabbards described above where the first ice skate scabbard will receive approximately the front half of the ice skate blade, and the second ice skate scabbard will receive approximately the rear half of the ice skate blade

The ice skate scabbard assembly may further comprise a third ice skate scabbard having a body for receiving the blade of a second ice skate, the body having a front end, two side ends, and a bottom, wherein an opening is formed between the two side ends and the front end for receiving the second ice skate blade; and a fourth ice skate scabbard having a body for receiving the blade of the second ice skate, the body having a front end, two side ends, and a bottom, wherein an opening is formed between the two side ends and the front end for receiving the ice skate blade, wherein at least one traction device is attached to the bottom of the body of the third ice skate scabbard via at least one attachment element, and wherein at least one traction device is attached to the bottom of the body of the forth ice skate scabbard via at least one attachment element, and wherein the third ice skate scabbard and the fourth ice skate scabbard are used in combination to receive the blade of the second ice skate.

One or more traction devices per ice skate scabbard can be present in this embodiment.

In certain embodiments, the invention may be constructed with very coarse grit (abrasive particles or granules, such as sand or other small, coarse impurities) imbedded in a waterproof base that is secured to the scabbard by glue and/or cement. The grit may also be applied to a material or fabric, which may be attached or secured to the bottom of the scabbard via the attachment element.

The material housing the coarse grit may not extend completely to the edge of the scabbard in order to prevent the edges of the material from fraying.

In other embodiments, the material housing the coarse grit may extend completely to the edge of the scabbard. This allows a wearer of the ice skate scabbard to have traction/friction when applying weight to all edges of the ice skate scabbard when wearing the ice skate scabbard. Moreover, this may allow a wearer of the ice skate and ice skate scabbard assembly to push off an edge, specifically the inner edge of an ice skate, while still maintaining friction/traction.

The invention may additionally be accounted for in the construction of the scabbard so as to provide scabbards with the invention built in. Indentations in the scabbard mold for the invention and a securing system for the invention may be constructed. An additional indentation approximately 1.5 inches long by 0.5 inches high with a writable surface may be provided on the side of each scabbard for the owner to write their name to prevent loss or confusion of ownership at a skating event. These additions may make a competitive potion of difference to competition in a scabbard market that has few significant differences between brands.

Other embodiments of the invention also may have the traction device applied not only on the flat portion of the scabbard, but also may extend upwards towards the toe or heal of the blade (away from the flat surface) to facilitate a natural walk by a user.

Embodiments of the invention may be applied to any semi-hard scabbard material including plastic, nylon, rubber, leather, etc., with or without a smooth and continuous bottom surface that interacts with the walking surface.

The Applicant has fabricated a working prototype from readily available materials, and has reduced the invention to practice with favorable results. Surprisingly, the Applicant has discovered that the prototype is capable of fitting ice blade scabbards of different sizes and materials with no difficulty. The prototype was constructed with very coarse grit, #36, aluminum oxide imbedded by resin in a fabric backing secured to the scabbard by glue/cement. The coarse grit number #36 was made by Norton Abrasives, (Norton #48521 3″×21″ 36 grit sanding belts, 3-pack), which is available as a commercial product. The 36 grit means that in a 1-inch square piece, 36 grit particles are present.

In the working prototype, there are two traction devices per scabbard, each measuring approximately 7″ long. The working prototype was fabricated for two ice skate scabbards, each scabbard having two traction devices.

Other working prototypes involve using grit #24. Grit #24 means that in a 1-inch square piece, 24 grit particles are present. The 24 grit particles are larger than 36 grit particles.

In certain embodiments, the grit is embedded in a resin base that holds the grit together and attaches to a fabric backing. The fabric backing is water proof in certain embodiments. Moreover, in certain embodiments, the fabric backing is attached to the ice skate scabbard via a double-sided tape that is pressure sensitive.

It is advantageous for the fabric backing to be waterproof as often ice may melt and water may adhere to the scabbard. It is advantageous for larger grit particles to be used with the resin as this allows greater traction if snow or shavings are on the ice.

Other objects of the invention may be achieved by providing a kit for making an ice skate scabbard less slippery comprising: an ice skate scabbard having a body for receiving the ice skate blade, the body having a front end, two side ends, a rear end, and a bottom, wherein an opening is formed between the two side ends, the front end and the rear end for receiving the ice skate blade; at least one traction device; and at least one attachment element, wherein said at least one traction device is attached to the bottom of the body of the ice skate scabbard via the at least one attachment element, and wherein the ice skate blade fits within the body of the ice skate scabbard.

Other objects of the invention may be achieved by providing a method for assembling an ice skate scabbard comprising providing an ice skate scabbard having a body for receiving an ice skate blade, the body having a front end, two side ends, a rear end, and a bottom, wherein an opening is formed between the two side ends, the front end and the rear end for receiving the ice skate blade; providing at least one traction device; and attaching the at least one traction device to the bottom of the ice skate scabbard via at least one attachment element.

The method may further comprise placing the ice skate within the body of the ice skate scabbard. The method may further comprise removing the at least one traction device from a retaining element.

The method may further involve having the at least one attachment element be located on one side of the at least one traction device.

The invention is not limited to these embodiments, or to the fabricated prototype for that matter, as other combinations to produce a ice scabbard with traction device attached to the bottom to allow for a user to walk onto ice while wearing the scabbard are contemplated by the invention.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a perspective view of one piece of an ice skate scabbard of the two-piece scabbard design having at least one traction device. The second half is identical to the first half; and

FIG. 2 is a perspective view of the traction device showing coarse grit particles and attached to a retaining element; and

FIG. 3 is a perspective view of the traction device showing attached to a retaining element.

### DETAILED DESCRIPTION OF THE INVENTION

Referring now to FIG. 1, an ice skate scabbard 100 is shown having at least one traction device 150. Also shown are front end 105, rear end 110 and side end 120 of ice skate scabbard. Side end 125 is not shown. The front end 105 is shown sweeping upwardly away from the bottom end. An ice skate blade 500 is shown and may align with the front end 105 of ice skate scabbard 100, and may fit in an opening between the front end 105, two side ends 120 and 125 and rear end 110 of the ice skate scabbard.

FIG. 1 also shows spaces 155 and 165 which are between the side ends 120 and 125 and the at least one traction device 150. These spaces are used to prevent fraying of the at least one traction device 150. Furthermore, space 170 is shown between the at least one traction device 150 and rear end 110 of the scabbard, while space 175 is not shown, which is between at least one traction device 150 and front end 105. Space 175 is also for preventing fraying of the at least one traction device 150.

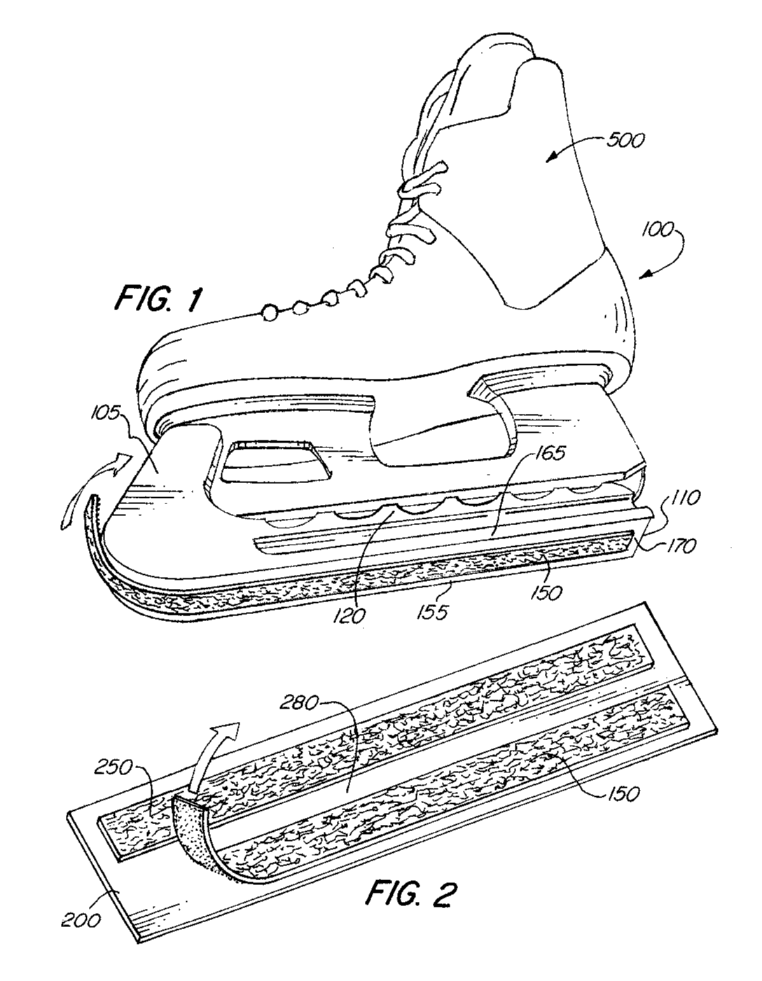

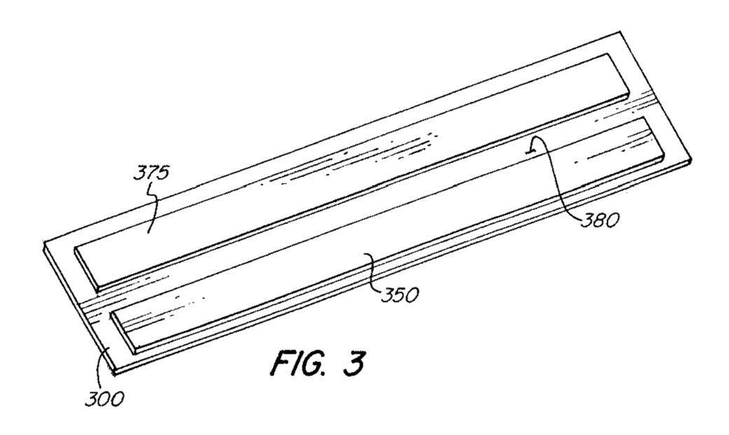

FIG. 2 is a flat view of at least one traction device 150 showing coarse grit particles 200 or other such traction particles. The coarse grit particles or other such traction particles or surfaces are used to provide friction/traction while walking on ice. This allows for friction/traction between the ice skate scabbard 100 and ice to prevent a wearer of the ice skate scabbard from falling and sustaining a serious injury.

The at least one traction device 150 is shown on retaining element 280, which is a surface to which the at least one traction device 150 sticks to, prior to being removed and installed on ice skate scabbard 100. A second traction device 250 is also shown sticking to retaining element 280. Retaining element 280 may be any type of surface material that the at least one traction device 150 sticks to prior to being removed and installed on ice skate scabbard 100.

Ice skate scabbard 100 may part of a two-piece scabbard design per ice skate where ice skate scabbard 100 and a second ice skate scabbard (not shown) are used to receive and hold a single ice skate blade. A spring can be used to connect each one of the scabbards that receive an ice skate in the two-piece scabbard design.

Furthermore, the at least one traction device 150 may be split into various pieces on retaining element 280, so that more than one traction device 150 may be installed on an ice skate scabbard 100.

FIG. 3 of the invention shows a perspective view of the at least one traction device 350 and 375 being attached to a retaining element 380. Here, the at least one traction device 350 and 375 are shown not having coarse particles. Instead, other such materials and/or combination of materials may be used to allow for friction/traction between the ice skate scabbard 100 and ice to prevent a wearer of the ice skate scabbard from falling and sustaining a serious injury.

While the invention has been specifically described in connection with certain specific embodiments thereof, it is to be understood that this is by way of illustration and not of limitation and that various changes and modifications in form and details may be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. An ice skate scabbard assembly for receiving a blade of an ice skate, said assembly comprising:
an ice skate scabbard having a body for receiving the blade of the ice skate, the body having a front end, two side ends, a rear end, and a bottom, wherein an opening is formed between the two side ends, the front end and the rear end for receiving the ice skate blade;
at least one traction device; and
at least one attachment element, wherein said at least one traction device is attached to the bottom of the body of the ice skate scabbard via the at least one attachment element.

2. The ice skate scabbard assembly of claim 1, wherein said at least one traction device is formed of sandpaper, metal oxide, or grit.

3. The ice skate scabbard assembly of claim 1, wherein the at least one attachment element is composed of glue, cement, or double-sided sticky tape.

4. The ice skate scabbard assembly of claim 1, wherein the at least one traction device extends from the front end of the scabbard to the rear end of the scabbard along the bottom of the body of the scabbard.

5. The ice skate scabbard assembly of claim 1, wherein spaces are formed between the edges of the at least one traction device and the two side ends of the body of the scabbard, said spaces used for preventing the edges of the at least one traction device from fraying.

6. The ice skate scabbard assembly of claim 1, wherein a spaces are formed between the edges of the at least one traction device and the front and rear ends of the body of the scabbard, said spaces used for preventing the edges of the at least one traction device from fraying.

7. The ice skate scabbard assembly of claim 2, wherein the metal oxide is aluminum oxide.

8. The ice skate scabbard assembly of claim 1, wherein the front end of the body of said scabbard sweeps upwardly.

9. The ice skate scabbard assembly of claim 1, wherein the at least one traction device is aluminum oxide imbedded by resin in a fabric.

10. The ice skate scabbard assembly of claim 1, further comprising two traction devices.

11. The ice skate scabbard assembly of claim 1, further comprising three traction devices.

12. The ice skate scabbard assembly of claim 1, further comprising:
a second ice skate scabbard having a body for receiving a blade of a second ice skate, the body having a front end, two side ends, a rear end, and a bottom, wherein an opening is formed between the two side ends, the front end and the rear end for receiving the second ice skate blade;
a second traction device; and
a second attachment element; wherein said second traction device is attached to the bottom of the body of the ice skate scabbard via the second attachment element.

13. The ice skate scabbard assembly of claim 12, wherein the first ice skate scabbard has two traction devices and the second ice skate scabbard has two traction devices.

14. A traction device for an ice skate scabbard comprising:
a strip of material made from either sandpaper or metal oxide, wherein said material is attached to the bottom of an ice skate scabbard via an attachment element.

15. The traction device of claim 14, wherein said traction device is applied to any semi-hard scabbard material.

16. The traction device of claim 15, wherein semi-hard scabbard material comprises plastic, nylon, rubber, wood or leather.

17. The traction device of claim 14, wherein the at least one traction device is formed of sandpaper, metal oxide, or grit.

18. The traction device of claim 14, wherein the attachment element is composed of glue, cement, or double-sided sticky tape.

19. The traction device of claim 17, wherein the metal oxide is aluminum oxide.

20. An ice skate scabbard assembly for receiving a blade of an ice skate, said assembly comprising:
an ice skate scabbard having a body for receiving the blade of the ice skate, the body having a front end, two side ends, a rear end, and a bottom, wherein an opening is formed between the two side ends, the front end and the rear end for receiving the ice skate blade;
at least one traction device; and
an attachment element, wherein said at least one traction device is attached to the bottom of the body of the ice skate scabbard via the attachment element, and wherein the at least one traction device is made from aluminum oxide imbedded by resin in a fabric.

21. An ice skate scabbard assembly for receiving a blade of an ice skate, said assembly comprising:
a first ice skate scabbard having a body for receiving the blade of the ice skate, the body having a front end, two side ends, and a bottom, wherein an opening is formed between the two side ends and the front end for receiving the ice skate blade;
a second ice skate scabbard having a body for receiving the blade of the ice skate, the body having a front end, two side ends, and a bottom, wherein an opening is formed between the two side ends and the front end for receiving the ice skate blade;
at least two traction devices; and
at least two attachment elements, wherein at least one traction device is attached to the bottom of the body of the first ice skate scabbard via the at least one attachment element, and wherein at least one traction device is attached to the bottom of the body of the second ice skate scabbard via at least one attachment element, and
wherein said first ice skate scabbard and said second ice skate scabbard are used in combination to receive the blade of the ice skate.

22. The ice skate scabbard assembly of claim 21, further comprising:
a third ice skate scabbard having a body for receiving the blade of a second ice skate, the body having a front end, two side ends, and a bottom, wherein an opening is formed between the two side ends and the front end for receiving the second ice skate blade; and
a fourth ice skate scabbard having a body for receiving the blade of the second ice skate, the body having a front end, two side ends, and a bottom, wherein an opening is formed between the two side ends and the front end for receiving the ice skate blade,
wherein at least one traction device is attached to the bottom of the body of the third ice skate scabbard via at least one attachment element, and wherein at least one traction device is attached to the bottom of the body of the forth ice skate scabbard via at least one attachment element, and
wherein said third ice skate scabbard and said fourth ice skate scabbard are used in combination to receive the blade of the second ice skate.

23. The ice skate scabbard assembly of claim 1, wherein the at least one traction device makes the bottom of the ice skate scabbard less slippery.

24. A method of assembling an ice skate scabbard comprising:
providing an ice skate scabbard having a body for receiving an ice skate blade, the body having a front end, two side ends, a rear end, and a bottom, wherein an opening is formed between the two side ends, the front end and the rear end for receiving the ice skate blade;
providing at least one traction device; and
attaching the at least one traction device to the bottom of the ice skate scabbard via at least one attachment element.

25. The method of claim 24, further comprising placing the ice skate within the body of the ice skate scabbard.
